(19) United States
(12) Patent Application Publication
(10) Pub. No.: US 2011/0251890 A1
(43) Pub. Date: Oct. 13, 2011

(54) SYSTEM FOR COMMERCIAL INFORMATION TRANSMISSION AND ITS APPLIED METHOD THEREIN

(76) Inventor: Wencheng XU, Shanghai City (CN)

(21) Appl. No.: 12/758,066

(22) Filed: Apr. 12, 2010

(51) Int. Cl. G06Q 30/00; G06F 15/16; H04N 7/26; G06Q 10/00

(52) U.S. Cl. 705/14.44; 705/14.47; 705/14.64; 709/203

(57) ABSTRACT

A system for electronic commercial information transmission, and the method for electronic information transmission applied therein. The system comprises a server and at least one portable work station that can communicate with the server on which a combination of free multi-media information are stored. The multi-media information is played free of charge with non-limited times. The music group and commercial goods will gradually become famous. The actions for watching the commercial information will enlarge the market for multi-media information download and the commodities business. This system will enclose the combination of the said multi-media information and commercial information in the greeting card and send the same to whose lover and families to offer the festival wishes, and this card, further to the multi-media information and commercial information will easily become the gossip topic of the public.

### TECHNICAL FIELD

This invention relates to an electronic commercial system, in particular, it refers to a system for electronic commercial information transmission, and the method for electronic information transmission applied therein.

### BACKGROUND OF THE INVENTION

It applies the combination of free multi-media information with popular elements and the commercial information to obtain better public praise, wherein the multi-media information is played free of charge with non-limited times. And the music group and commercial goods will gradually become famous. The actions for watching the commercial information will enlarge the market for multi-media information download and the commodities business. This system will enclose the combination of the said multi-media information and commercial information in the greeting card and send the same to whose lover and families to offer the festival wishes, and this card, further to the multi-media information and commercial information will easily become the gossip topic of the public. Because of the insertion of the commercial information in the process for watching the multi-media, the system simultaneously provides the greetings card for free to develop the additional value of the commercial information. Additionally, the image information of the said information would be partially printed on the paper carrier, and will thereby obtain a certain amount of greeting cards on paper carrier to enhance the commercial advertising effect. Meanwhile, the authentication is applied in the system for better administration, and the virtual identification names related to the workstations will provide better circumstance for mutual communication. And it also fully takes use of the public praise in “Shaming” anti-piracy system against the unauthorized use.

Actually, the related information advertising in the broadcast or the related advertisement in the commercial actions of the present society applies the print media, such as paper, magazine, leaflet or poster, and applies the multi-media, such as broadcasting, television or networks and so on to advertise the commodities or advertisers themselves, in order that the buyers will obtain the information of all kinds of commercial activities or the advertisers themselves, and the commodities and the advertisers will frequently appear in the sight of the buyers to advertise the related commodities or commercial activities.

Although the increasing kinds of advertisements is going more and more, but as to the buyers, all the present advertisements will been seen in the specific locations. But due to the limit of the region, the advertising effect is limited and is not good enough. Consequently, the advertisers apply the different technical scheme to break the limit of the region.

For example, It has disclosed that, in the Chinese patent application named “Business information sending system” bearing the publication number: CN1828662, this business information sending system comprises: at least an information providing platform to store and wireless send business different information to at least one receiver for processing and outputting or storing temporarily according to consumer, and different business activity center areas. Wherein, consumer can select according to interested information; it sends the special geographic location coordinate information to a navigation module for processing, applies GPS to detect the real-time location of receiving target and the navigation module to generate an optimal path between the target and start point, and then guides the consumer for consumption.

It has disclosed that, in Chinese patent application named “Method for loading and transmitting commercial information to data terminal” bearing the publication number: CN101237423, the method for loading or sending business information to a data terminal; according to a protocol, in the process of transmitting any realizable message to a receiving terminal of the data terminal in networks communication and any other realizable modes by a sending terminal of the data terminal, or after the receiving terminal of the data terminal receives the information, the receiving terminal of the data terminal can send any realizable feedback information according to a networks communication standard; according to a protocol, in the process of transmitting any realizable feedback information to the sending terminal of the data terminal in networks communication and any other realizable modes by the receiving terminal of the data terminal, the receiving terminal of the data terminal is operated according to the protocol; through any following mode or the organic combination of a plurality of modes: the sending terminal of the data terminal, the receiving terminal of the data terminal, an Internet operation service provider or the organic combination of the receiving terminal of the data terminal, the sending receiving terminal of the data terminal and the Internet operation service provider, a certain amount of reward can be obtained from a distribution service provider

It has disclosed that, in Chinese patent application named “Method for sending business information to data terminal” bearing the publication number: CN101093573, in this present application a method for sending commercial information to data terminal includes signal contract with selling firm by data terminal user, loading commercial information on information to be sent from data terminal user in networks communication mode by selling firm, sending said information together with loaded commercial information to data receiving terminal assigned by data terminal user then paying data terminal user by selling firm.

It has disclosed that, in Chinese patent application named “Merchandise information transmission method, apparatus and transmission system and server” bearing the publication number: CN101488211, the present invention is applicable to the technical field of a mobile terminal, and provided a method for sending merchandise information, a device, a transmission system and a server thereof. The method comprises the steps: the consuming information of the user at the mobile terminal is acquired; the acquired consuming information of the user is treated by classifying and ordering; according to the result of the treatment of classifying and ordering, the related merchandise information is sequentially matched, and the matched merchandise information is transmitted to the mobile terminal. By classifying the consuming information of the user and matching the related merchandise information with the consuming information of the user to prompt the user, the invention can ensure the user to conveniently and quickly select the merchandise information, thus being greatly convenient for use and expanding the functions of the mobile terminal.

Although they provides different methods for commercial information transmission in the said different patent technical documents, so as to enhance the transmission effect of the commercial advertisement, but all of them will not obtain the enough good advertising effect, and all the methods for commercial information transmission are in the same way, but do not easy enough to be accepted in by the public.

Consequently, this invention is to provide a system for advertising the commercial information which will combine the popular elements and disregard the limit of the region, this invention further discloses a method for electronic information transmission to send different information to the related users respectively.

### SUMMARY OF THE INVENTION

The purpose of this invention is to provide a system for advertising the commercial information by combining with the multi-media information with popular elements, to disregard the limit of regions.

Meanwhile, another purpose of this invention is to provide a method for commercial information transmission applied in the said system.

The technical scheme to realize the purposes of this invention is as follow:

A system for transmitting the commercial information, with the structure of star topology networks, this system comprises: the server including a storage device in which the multi-media information and the commercial information are totally saved; at least a workstation which is a portable equipment to communicate with the user and display the multi-media information and commercial information received from the said server, all the workstations are connected to the said server, information transmission networks, the said portable equipment as the workstation is connected with the said storage device in the server in bi-direction for digital transmission via information transmission networks, in order that not only to send the necessary information from the server to the workstations, but also to provide the feedback from the workstations to the server according to the information received, meanwhile the workstations will be in timely communication.

Communication interfaces are applied in both the server and the workstations, and these interfaces in the in the server and workstations are connected with each other via information transmission networks. These interfaces are adapted to the information transmission networks, and they may be the concrete connection interfaces, or may be the virtual connection interfaces.

Preferably, the said server is connected with the workstation in wireless mode of the information transmission networks, additionally, the said workstations are connected with each other via the information transmission networks to communicate with each other. It comprises the editable module in each workstation, such as: keyboard and so on, and the said editable module would send the feedback to the said server according to the input of the user.

It further comprises the identification module for identifying the identification code provided by the identification transmission module in the server, which is very important for this system and will further be explained below.

Preferably, the said workstations are the portable computer, palmtop or mobile-phone, all of which could play the Video and Audio. Actually, all the portable electronic device, which could be connected to the networks, would be available as the workstation.

Additionally, it applies the anti-pirate system against the unauthorized use of the information in the server. In specific, this anti-pirate system would implant the embedded program into the said multi-media information to take the interruption against the unauthorized use of the multi-media information, and inform all the other workstations which are in communication with.

The information transmission method applied in the said commercial information transmission system, this method comprises:

(1) it applies the combination of the multi-media information and commercial information, which is pre-stored in the said server, and the mapping relationship is applied between the said workstation and the unique feature of the user, and preferably, the unique feather herein is the identification of the user of the workstation;

(2) as above, the combination in fixed format of the multi-media information and commercial information is transmitted to the workstation via the said information transmission networks between the said server and workstations;

(3) The multi-media information and the commercial information are played in real time or not.

(4) The user may send the feedback according to the multi-media information and the commercial information.

The said unique feature of the workstation is the identification code of the user, and the said server will send different combinations of the multi-media information and the commercial information according to different identification codes related to the workstations.

The said workstations and the said identification codes are in one-to-one mapping relationship, but different identification codes of the workstations and the marks in the mark-table in the server are in many-to-one mapping relationship, every mark relates to the combination of multi-media information and commercial information, the said server would send the combination of multi-media information and commercial information according to the mapping relationship of the marks and the identification codes.

Every said one identification code is in relation with several virtual identification names, for the identity confirmation in the communication between the workstations or between the workstations and the server. These identification names are used in the communication of the workstations, and different identification names will be applied according to the different content in the communication to facilitate the communication in the whole system.

The said combination of the multi-media information and the commercial information in compression format is in encryption transmission between the said server and the said workstation to secure the information transmission. Additionally, the server could accept the feedback from the workstation according to the commercial information, the feedback will be transmitted to the server via editable interface of the workstation.

The said multi-media information and commercial information are displayed as an electronic card format on the workstations, and the Video of the said multi-media information and the said commercial information are displayed simultaneously, and the Audio thereof will be played in sequence.

The said multi-media information is MV or DV etc, the said commercial information is advertisement etc.

Additionally, the image information of the multi-media information and commercial information will be printed or photocopied in the paper carrier, which will be another way for advertising to obtain the better advertising effect.

For applying the above technical scheme, this invention provides a system for advertising the commercial information by combining with the multi-media information with popular elements, to disregard the limit of regions, and further provides a method for commercial information transmission.

### BRIEF INTRODUCTION TO THE DRAWINGS

FIG. 1 illustrates the holistic structure schematic diagram of the system for commercial information transmission;

FIG. 2 illustrates the method for commercial information transmission applied in the system of FIG. 1;

FIG. 3 illustrates the display mode in the method of the commercial information transmission.

The names of the modules with the labeling are illustrated as below:
1 server, 2 workstation, 3 information transmission networks,

### THE PREFERRED EMBODIMENTS OF THE INVENTION

This invention is to provide a system for advertising the commercial information by combining with the multi-media information with the popular elements to disregard the limit of the region, and this invention further discloses a method for electronic information transmission to send advertising information.

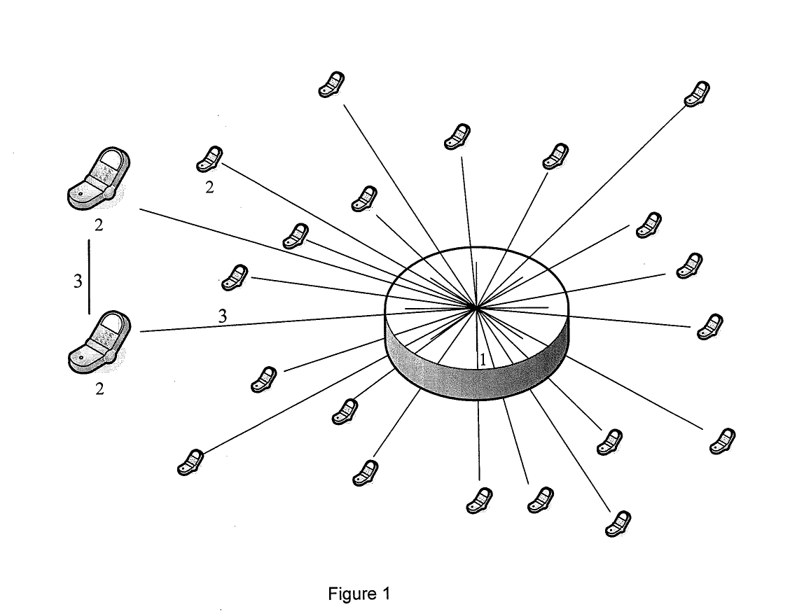

In FIG. 1, it provides the holistic construction schematic diagram of the system for commercial information transmission. Wherein it provides a system for commercial information transmission with the structure of star topology in which the server 1 is the center. The whole system comprises: the server 1 which includes the storage device in which the multimedia information and the commercial information are totally stored, the multi-media information therein should be combined with popular and amusement elements, preferably the MV, DV and so on, which are the multi-media information with the combination of Video and Audio, and the commercial information therein could be the introduction to commodities, the advertisements, and such other commercial advertising information; in addition, this system further comprises many workstations, all of which connect to the sever 1 by the information transmission networks 3, each workstation 2 is portable equipment to communicate with the user and display the multi-media information and commercial information received from the said server 1; the connection routes between the server 1 and workstations 2 constitute the information transmission networks 3 in this embodiment, the said portable equipment as the workstation 2 is connected with storage device in the server in bi-direction for digital transmission via information transmission networks 3, the server 1 could send the multi-media information and commercial information to the workstations 2 in the fixed format or form, additionally, the workstations 2 will provide the feedback to the server 1, so that the whole system will provide the closed information circuit. Additionally, the workstations 2 themselves are connected with each other by the said information transmission networks 3 for communication between themselves.

Communication interfaces are set on both the server 1 and the workstations 2, and they are connected via information transmission networks 3, and this information transmission networks 3 could apply the wired networks, wireless networks and the combination of wired/wireless networks, and the communication interfaces of the server 1 and workstations 2 would be the types of virtual interface or the concrete interface related to the different networks. But it is to be predicted that, the construction scale of the whole system will be limited if only the wired networks are available, therefore this invention is preferred to apply wireless signal transmission mode. Additionally, as the requirement of the feedback from the workstation 2 to server 1, therefore the user editable module is applied in the workstation 2, and the users will timely and effectively proceed with the feedback via the said editable module according to the combination of the multi-media and commercial information, in order to obtain the statistic of the commercial advertising effect, and accomplish the commercial activities.

Preferably, the said workstations 2 includes the portable computer, palmtop and mobile phone, all of which would display the Video and Audio of the multi-media information and the commercial information, in order to realize the purpose of the commercial information advertising.

Additionally, the anti-pirate module is further comprised in the system of this invention, this module will prevent unauthorized copy, by implanting the embedded program into the said electronic information, to take the interruption in the workstation which will be or is proceeding with the unauthorized copy and inform the other workstations 2 which are in communication with this workstation 2.

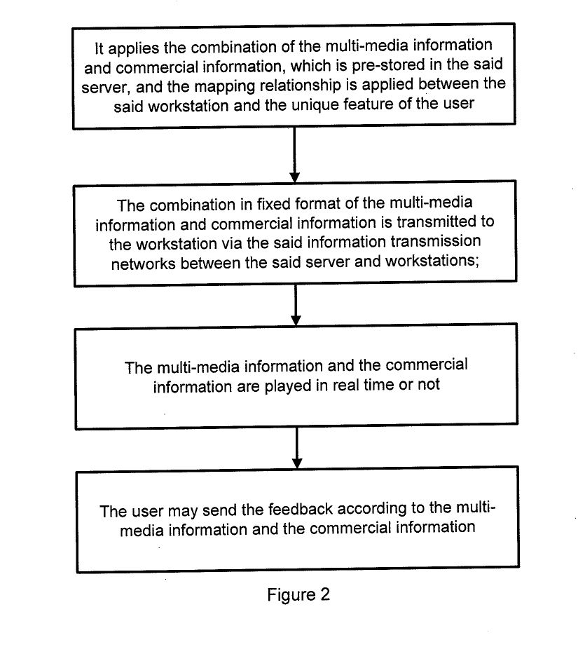

It illustrates, in FIG. 2, the flow chart of the method for commercial information transmission applied in the system of FIG. 1. This method for commercial information transmission applied in this system for commercial information transmission comprises the following steps:

(1) The combination of the multi-media information and commercial information is pre-stored in the said server 1, and the mapping relationship is applied between the said workstation and the unique feature of the user;
(2) The combination in fixed format of the multi-media information and commercial information is transmitted to the workstations 2 via the said information transmission networks 3 between the said server 1 and workstations 2;
(3) When the workstations 2 receive the said information, the multi-media information and the commercial information may be played in real time or not. In this preferred embodiment, the information received should be played in real time or not to guarantee the continuation in the whole playing process.
(4) If the users are interested in the commercial information displayed on the workstations 2, they may send the feedbacks according to the multi-media information and the commercial information.

In the said method, the unique feature applied is the identification code of the user, which could comprises several kinds, for example: Identity Card Number, Social Security Number and so on, or maybe the physical sign of the body, such as fingerprint, DNA and so on. As the said workstations 2 are related to the identification codes, a mark-chart is set in the server 1, each mark in this mark-chart is in connection with the related identification code. According to the relationship thereof, the workstations will receive different combinations of the multi-media information and commercial information, and the different information will be sent to different group and obtain the best advertising effect.

Additionally, it is to take further explanation that the said workstation 2 and identification codes are in one-to-one mapping relationship, but the identification codes of different workstations 2 and the marks in the said mark-chart in the server 1 are in many-to-one mapping relationship, it is to say that several identification codes could be in relation with only one mark in the mark-chart, each mark is related to a combination of multi-media information and commercial information, and before transmitting the combination of multi-media information and commercial information, it requests to test the said mark of the workstation 2, then the combination of the multi-media information and commercial information will be transmitted according to the mapping relationship. In the whole testing process, the transmission and receive of the identification code is conducted by transmitting and receiving module.

And in the workstation 2 of this invention, to facilitate the communication of the whole system, several virtual identification names are in relation with the identification codes, the virtual identification names are used for the communication between the workstations 2 or the daily communication between the server 1 and the workstations 2, these identification names are used to provide authentication for the communication between the workstations or between the workstation 2 and server 1, to make clear the identities of both parties in the communication.

The combination of the said multi-media information and commercial information applies the compression format in encryption transmission between the said server and workstations 2, to secure the information transmission, and the server 1 could receive the feedback from the workstations 2 according to the commercial information, the feedback will be transmitted to the server 1 via editable interface of the workstation.

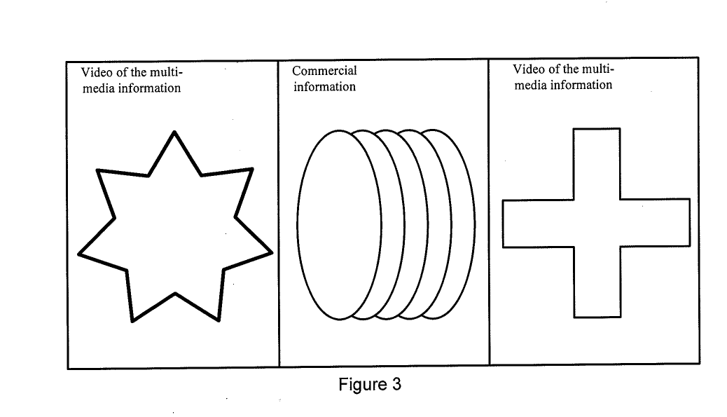

FIG. 3 illustrates the display mode in the method of the commercial information transmission. The said multi-media information and commercial information are displayed as an electronic card format on the workstation, and the Video of the said multi-media information and the said commercial information are displayed simultaneously, but the Audio thereof will be played in sequence. The said multi-media information will be MV and DV, the commercial information would be generally commercial advertisement.

Additionally, the image information of the multi-media information and commercial information will be printed or photocopied in the paper carrier, which is another method for transmitting to obtain better advertising effect.

By applying the above technical scheme, this invention is to provide a system for advertising the commercial information by combining with the multi-media information with popular elements, to disregard the limit of regions, and further provides a method for commercial information transmission. It applies the combination of free multi-media information with popular elements and the commercial information to obtain better public praise, wherein the multi-media information is played free of charge with non-limited times. And the music group and commercial goods will gradually become famous. The actions for watching the commercial information will enlarge the market for multi-media information download and the commodities business. This system will enclose the combination of the said multi-media information and commercial information in the greeting card and send the same to whose lover and families to offer the festival wishes, and this card, further to the multi-media information and commercial information will easily become the gossip topic of the public. Because of the insertion of the commercial information in the process for watching the multi-media, the system simultaneously provides the greetings card for free to develop the additional value of the commercial information. Additionally, the image information of the said information would be partially printed on the paper carrier, and will thereby obtain a certain amount of greeting cards on paper carrier to enhance the commercial advertising effect. Meanwhile, the authentication is applied in the system for better administration, and the virtual identification names related to the workstations will provide better circumstance for mutual communication. And it also fully takes use of the public praise in “Shaming” anti-piracy system against the unauthorized use.

The protective scope of this invention is not limited by the preferred embodiments, but the combination of the technical features of the claims is within the protective scope of this invention.

1. A system for transmitting the commercial information, with the structure of star topology networks, it is characterized that, this system comprises:
the server including a storage device in which the multi-media information and the commercial information are totally saved,
at least a workstation which is a portable equipment to communicate with the user and display the multi-media information and commercial information received from the said server, all the workstations are connected to the said server,
information transmission networks, the said portable equipment as the workstation is connected with the said storage device in the server in bi-direction for digital transmission via information transmission networks.

2. The commercial information transmission system of claim 1, it is characterized that, communication interfaces are applied in both the server and the workstations, and these interfaces in the in the server and workstations are connected with each other via information transmission networks.

3. The commercial information transmission system of claim 2, it is characterized that, the said server is connected with the workstation in wireless mode of the information transmission networks.

4. The commercial information transmission system of claim 1, it is characterized that, it comprises the editable module in the workstation, and the said editable module would send the feedback to the said server according to the input of the user.

5. The commercial information transmission system of claim 2, it is characterized that, it comprises the editable module in the workstation, and the said editable module would send the feedback to the said server according to the input of the user.

6. The commercial information transmission system of claim 1, it is characterized that, it further comprises the identification module for identifying the identification code provided by the identification transmission module in the server.

7. The commercial information transmission system of claim 2, it is characterized that, it further comprises the identification module for identifying the identification code provided by the identification transmission module in the server.

8. The commercial information transmission system of claim 1, it is characterized that, the said workstations are the portable computer, palmtop or mobile-phone, all of which could play the Video and Audio.

9. The commercial information transmission system of claim 1, it is characterized that, it applies the anti-pirate system in the server, and this system would implant the embedded program into the said multi-media information against the unauthorized use of the multi-media information.

10. The information transmission method applied in the said commercial information transmission system of claim 1, it is characterized that,
(1) it applies the combination of the multi-media information and commercial information, which is pre-stored in the said server, and the mapping relationship is applied between the said workstation and the unique feature of the user;
(2) as above, the combination in fixed format of the multi-media information and commercial information is transmitted to the workstation via the said information transmission networks between the said server and workstations;
(3) the multi-media information and the commercial information are played in real time or not.
4) the user may send the feedback according to the multi-media information and the commercial information.

11. The information transmission method of claim 10, it is characterized that, the said unique feature of the workstation is the identification code of the user, the said server will send different combinations of the multi-media information and the commercial information according to different identification codes related to the workstations.

12. The information transmission method of claim 11, it is characterized that, the said workstations and the said identification codes are in one-to-one mapping relationship, but different identification codes of the workstations and the marks in the mark-table in the server are in many-to-one mapping relationship, every mark relates to the combination of multi-media information and commercial information, the said server would send the combination of multi-media information and commercial information according to the mapping relationship of the marks and the identification codes.

13. The information transmission method of claim 12, it is characterized that, every said one identification code is in relation with several virtual identification names, for the identity confirmation in the communication between the workstations or between the workstations and the server.

14. The information transmission method of claim 11, it is characterized that, the said combination of the multi-media information and the commercial information in compression format is in encryption transmission between the said server and the said workstation, the server could accept the feedback from the workstation according to the commercial information, the feedback will be transmitted to the server via editable interface of the workstation.

15. The information transmission method of claim 10, it is characterized that, the said multi-media information and commercial information are displayed as an electronic card format on the workstations, and the Video of the said multi-media information and the said commercial information are displayed simultaneously, and the Audio thereof will be played in sequence.

16. The information transmission method of claim 15, it is characterized that, the said multi-media information is MV or DV, the said commercial information is advertisement.

17. The information transmission method of claim 15, it is characterized that, the image information of the multi-media information and commercial information will be printed or photocopied in the paper carrier.

18. The information transmission method of claim 16, it is characterized that, the image information of the multi-media information and commercial information will be printed or photocopied in the paper carrier.
